(19) United States
(12) Patent Application Publication
(10) Pub. No.: US 2008/0025016 A1
(43) Pub. Date: Jan. 31, 2008

(54) Child Safety Night Light

(76) Inventor: Michael Miskin, Sleepy Hollow, IL (US)

Correspondence Address: FACTOR & LAKE, LTD, 1327 W. WASHINGTON BLVD., SUITE 5G/H, CHICAGO, IL, 60607, US

(21) Appl. No.: 11/828,229

(22) Filed: Jul. 25, 2007

Related U.S. Application Data
(60) Provisional application No. 60/833,030, filed on Jul. 25, 2006.

(51) Int. Cl. H01R 33/00

(52) U.S. Cl. 362/95; 362/641; 362/642

(57) ABSTRACT

A lighting device comprising a lighting fixture having a light source. The lighting fixture defining a housing for the light source. The housing defining exterior surfaces including a surface portion from which connectors protrude for electrical connection to a mains power outlet; and, surface portion defining a cover at least substantially covering the light source and having a perimeter of coverage. The cover being shaped to be difficult or awkward to grasp for removal.

### CROSS REFERENCE TO RELATED APPLICATIONS

This application relies on the priority of U.S. Ser. No. 60/833,030 filed Jul. 25, 2006.

### TECHNICAL FIELD

The present application relates generally to the field of night lights and more particularly to a child safety night light.

### BACKGROUND OF THE INVENTION

Night lights are convenient energy saving devices which permit an adequate amount of light for certain purposes when the main lighting of a dwelling is not energized. In particular, night lights are in common use with children for diminishing fear of total darkness and permitting parental observation of a child without turning on main lighting which could wake the child. Nightlights also permit safe traverse through a dwelling for children when the main lighting is off. This is especially important for children who are too short to reach wall mounted light switches.

One problem with children is the risk of electrical shock by the children inserting either their finger or a conductive object into a wall mounted electrical socket. While others have developed various devices to cover an electrical socket to prevent this, when a night light is employed in such a socket, it prevents installing a convenient blocking device. Conventional night lights, on the other hand, are designed in a shape and or configuration which permits children to effectively grasp them which can result in removal and an providing access to an open socket. The present invention solves this problem (and others) while providing a unique night light which can prevent or greatly reduce dislodgement by a child while optionally blocking access by the child to other openings in the same wall outlet (or the like).

### SUMMARY OF THE INVENTION

In a main aspect of the invention a night light is provided which “plugs into” standard mains outlets and has a shape that is difficult to remove without a tool or a degree of effort not likely to be made by or available to a child. A separate aspect of the invention is the provision of a night light which blocks direct access to other outlets in the same electrical fixture to which it is connected for functional power. In one embodiment, a child safety night light is sized and configured to plug into a standard outlet and covers the entire outlet. In one embodiment, the lighting element and electrical components are housed in a fixture which presents only rounded, smooth or awkward outward contours when plugged in, making it difficult to grasp and unplug by a child or adult without added difficulty or a tool.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a front view of a light fixture according to one embodiment of the present invention;

FIG. 2 is a side view of the light fixture of FIG. 1;

FIG. 3 is another front view of the light fixture of FIG. 1 shown in size perspective with respect to a standard mains power outlet cover or “wall plate;”

FIG. 4 is a cross sectional view of the light fixture of FIG. 1 taken along line 4-4 of FIG. 3; and,

FIG. 5 is a plan view of a representation of a solid state lighting source for incorporation into the lighting fixture of FIG. 1.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

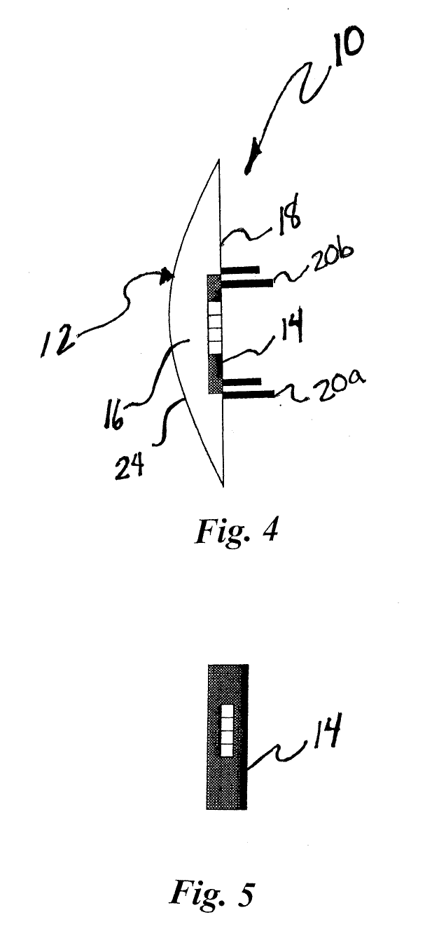

FIG. 4 discloses a lighting device 10 having a lighting fixture 12 and a light source 14. The light source 14 as disclosed in FIG. 5 is preferably a solid state light such as an LED, but in other embodiments may be any other conventional source such as a low wattage incandescent bulb and associated electrical circuits.

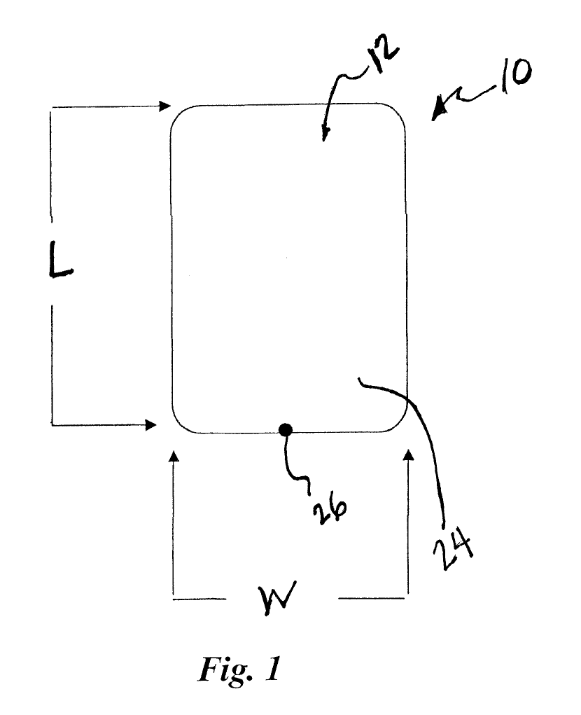

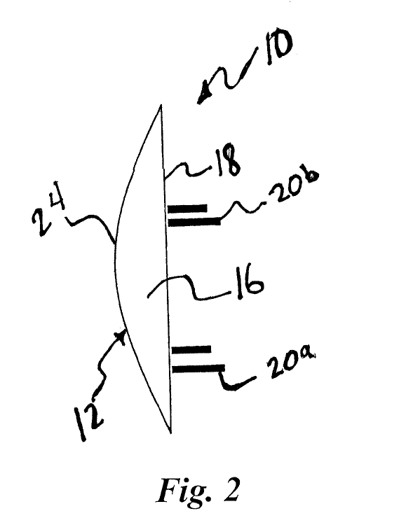

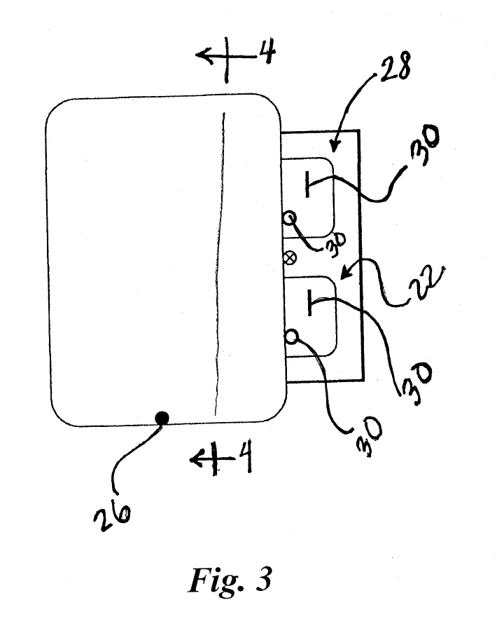

FIGS. 1 and 2 disclose that the lighting fixture 12 defines a housing 16 for the light source 14. The housing 16 presents or defines exterior surfaces including a surface portion 18 from which connectors 20a and 20b protrude for electrical connection to a typical mains power outlet 22 (see also FIG. 3 for outlet 22) and presents or defines a surface portion defining a cover 24 at least substantially covering the light source 14. The cover 24 is intentionally shaped to be awkward and/or difficult to grasp for removal. In the preferred embodiment disclosed cover 24 is shaped to present to a user substantially only rounded or curved profiles, which in this case are also generally convex, in fact domed with respect to the surface portion from which the electrical connectors protrude. However, it is contemplated that many other geometries could be used to define a surface for the cover to impede a user from getting a good grasp on the lighting fixture. One way to do this is to provide a lack of edges or leverage surfaces. Another way is to use size and shape to make grasping awkward to a child-sized hand.

The lighting fixture 12 of device 10 also includes a portion thereof sized and configured to cooperate with a tool (not shown) or other external device for removal of the lighting device 10 from the mains outlet 22 by an adult. FIGS. 1 and 3 disclose in this case (although many other possibilities will come to the mind of one of ordinary skill in the art in view of this disclosure) a small rounded opening 26 into which a small rod-like tool (not shown) can be inserted to provide a user leverage for removal of the device 10 from the outlet 22 when desired.

While not shown in the FIGS. the lighting device 10 may also be equipped with an ambient light detector operatively coupled to the light source 14 for automated on/off switching depending on the ambient light conditions.

The lighting fixture 12 of the device 10 has a perimeter or foot-print as disclosed in FIG. 1 by the reference letters L and W. As disclosed in FIG. 3, the perimeter or foot print covers the entire wall plate 28 of the outlet 22 not only to block access to all of the openings 30 of the outlet 22 but potentially to assist in preventing a good grip on the fixture 12. In other embodiments it is contemplated that devices according to the invention may make it difficult to grasp and remove the fixture without blocking access to other openings 30 in the outlet 22 whether there be one or more openings still remaining unblocked. In yet other embodiments the perimeter can be sized to block one or more other openings besides those under the fixture 12, but only to the extent necessary to block the openings versus covering an entire wall plate such as wall plate 28.

It is to be understood that additional embodiments of the lighting device 10 described herein may be contemplated by one of ordinary skill in the art in view of this disclosure and that the scope of the present invention is not limited to the embodiments disclosed. While specific embodiments of the present invention have been illustrated and described, numerous modifications can come to mind without significantly departing from the spirit of the invention, and the scope of protection is only limited by the scope of the accompanying claims.

What is claimed is:

1. A lighting device comprising:
a lighting fixture having a light source;
lighting fixture defining a housing for the light source;
the housing defining exterior surfaces including a:
(a) a surface portion from which connectors protrude for electrical connection to a mains power outlet; and,
(b) a surface portion defining a cover at least substantially covering the light source and having a perimeter of coverage,
the cover being shaped to be awkward or difficult to grasp for removal.

2. The lighting device of claim 1 wherein the cover shape presenting to a user substantially only rounded or curved profiles.

3. The lighting fixture of claim 1 wherein the cover shape is generally convex with respect to the surface portion from which the electrical connectors protrude.

4. The lighting device of claim 1 wherein the lighting fixture includes a portion thereof sized and configured to cooperate with a tool or other external device for removal of the lighting device from the mains outlet.

5. The lighting device of claim 1 having at least one light emitting diode as the light source.

6. The lighting device of claim 1 having an ambient light detector operatively coupled to the light source for automated on/off switching depending on the ambient light conditions.

7. The lighting device of claim 1 wherein the perimeter of the cover covering at least the remaining openings for all of the connections on the outlet.

8. The lighting device of claim 1 wherein the perimeter of the cover covering at least the entire wall plate of the outlet.

9. The lighting device of claim 2 wherein the perimeter of the cover covering at least the remaining openings for all connections on the outlet.

10. The lighting device of claim 2 wherein the perimeter of the cover covering at least the entire wall plate of the outlet.

11. The lighting device of claim 3 wherein the perimeter of the cover covering at least the remaining openings for all of the connectors on the outlet.

12. The lighting device of claim 3 wherein the perimeter of the cover covering at least the entire wall plate of the outlet.

13. The lighting device of claim 2 wherein the cover shape is generally dome-shaped.

14. The lighting device of claim 3 wherein the convex cover shape is generally dome- shaped.

15. The lighting device of claim 14 wherein the lighting fixture includes a portion thereof sized and configured to cooperate with a tool or other external device for removal of the lighting device from the mains outlet.

16. The lighting device of claim 14 having at least one light emitting diode as the light source.

17. The lighting device of claim 14 having an ambient light detector operatively coupled to the light source for automated on/off switching depending on the ambient light conditions.

18. The lighting device of claim 15 wherein the perimeter of the cover covering at least the remaining openings for all of the connections on the outlet.

19. The lighting device of claim 15 wherein the perimeter of the cover covering at least the entire wall plate of the outlet.

20. The lighting device of claim 19 wherein the perimeter of the cover covering at least the entire wall plate of the outlet.
